(19) United States
(12) Patent Application Publication
(10) Pub. No.: US 2015/0302511 A1
(43) Pub. Date: Oct. 22, 2015

(54) Direct Delivery Shopping System

(71) Applicant: Minerva P. Lopez, Chicago, IL (US)

(72) Inventor: Minerva P. Lopez, Chicago, IL (US)

(21) Appl. No.: 14/256,001

(22) Filed: Apr. 18, 2014

(51) Int. Cl. G06Q 30/06; G06Q 10/08

(52) U.S. Cl. CPC G06Q 30/0635; G06Q 10/087; G06Q 10/0836

(57) ABSTRACT

This invention relates to a direct delivery shopping system which is laid out with one or more order placement centers and a restricted delivery area having a plurality of delivery counters, conveyor belts, employee passageways, storage areas housing specific sale items, storage areas for packaged items and transport elevators. All components of the direct delivery shopping system can radiate from the center of the direct delivery area. These areas are so spaced and so connected in order to retain the polygonal nature of the direct delivery shopping area. The arrangement of the direct delivery area allows a customer to purchase items efficiently while using the direct delivery shopping system's online system and to retrieve the purchased items directly from a plurality of delivery counters or conveyor belts in the direct delivery area.

### CROSS-REFERENCE TO RELATED APPLICATIONS

“Not Applicable”

### STATEMENT REGARDING FEDERALLY FUNDED RESEARCH OR DEVELOPMENT

“Not Applicable”

### THE NAMES OF THE PARTIES TO A JOINT RESEARCH AGREEMENT

“Not Applicable”

### BACKGROUND OF THE INVENTION

The present invention relates to a direct delivery shopping system that may be integrated into an existing shopping center and more particularly to an improved shopping system for the distribution of purchased items using established technology. This system seeks to prevent shoplifting and to improve a customer's shopping experience. Embodiments of this invention also include a direct delivery shopping system having a basement and additional floors for receiving, storing, packing and tracking items.

Shoplifting has become a major problem for most retail stores. Shoplifters steal from a wide variety of stores including supermarkets, department stores and convenience stores. Besides the legal effects on the offender, shoplifting overburdens our legal system, causes the cost of goods to increase and increases the cost of a retail store's security system. This affects families and the quality of life in communities.

To this end, there have been a number of systems developed in order to prevent shoplifting. Current security measures include but are not limited to stick-on labels or shoplifting prevention tags that can be detected by sensors at store exits. Stick-on labels and tags can be found in various sizes and thickness and can be hidden inside items that have been offered for sale or wrapped on the exterior of the items. The devices can be disabled at the time of payment or by subjecting them to specific emission processes. However, such deactivation processes are not sufficiently reliable. Repeated bending or tearing can cause such devices to malfunction. In addition, customers can easily remove such devices in an attempt to shoplift.

Later improvements to devices to prevent shoplifting include wired tags that are wrapped around boxes or packages. These wired tags proved to be inefficient in that it took a substantial amount of time and cost to mount the devices on packages and the overall appeal of the products was diminished. In addition, the wires would loosen and the packages would ultimately loose protection.

The Food Marketing Institute has reported than in 2012, consumers made an average of 1.7 trips to the supermarket per week. This includes weekly stock-up trips and multiple fill-in trips. Consumers visited various store formats in order to purchase an assortment of products or to buy non-perishable items.

The retail items, limited assortment store, superstore, drugstore and supermarket industries have placed importance on finding convenient methods for customers to select items, eliminating congestion during shopping and reducing customer checkout times. Shopping systems are typically laid out in a manner that allows customers to walk from aisle to aisle while inspecting items. Often times, store aisles are congested with shopping baskets and customers. This often makes it difficult for customers to properly inspect items. In addition, customers might travel longer distances in order to find one item. After selecting items, customers often proceed to checkout areas that are narrow and congested with shopping baskets and additional customers.

The invention will have a natural flow that expedites item purchase, direct delivery shopping system entry, order pickup and store exit. There is also less frustration with finding vehicles after shopping. After checkout, a customer can walk around the direct delivery shopping system's periphery in order to reach an exit that is near their vehicle in the parking lot. This will be convenient for individuals looking for a quick way to leave and to avoid inclement weather.

The multilevel shopping system is well known and used by a variety of retail stores. There is a general organization of goods on multiple levels and goods are organized into various categories. The problems associated with these systems include customers spending extra time and energy in order to find intended items. The system according to this invention overcomes these problems by prepackaging items into an easy to maneuver specialized delivery cart and by delivering the items to customers in a convenient way. This system has a specific workflow in a reasonably spaced area of the direct delivery shopping system. All entrances and exits can be arranged in close proximity to all conveyor belts and delivery counters. This is a superior method to the conventional approach.

Accordingly, it would be advantageous to provide a restricted delivery shopping system which may be easily integrated into an existing store or shopping complex. This system would also work for small retailers who sell a limited amount of quality items and would like to prevent shoplifting and protect the quality and integrity of those items.

### BRIEF SUMMARY OF THE INVENTION

It is therefore an objective of the present invention to address the above concerns and to provide a direct delivery shopping system which prevents shoplifting, has an improved store layout, provides for expedited delivery of orders to customers and reduces waiting times to retrieve orders.

Another objective of the present invention is to provide a checkout system that includes the ability to order online, order at a plurality of order placement centers or interact with employees at delivery counters. Customers could leave the direct delivery area using a plurality of exit gates that can be conveniently located near the plurality of conveyor belts and order placement counters. Specialized delivery carts can be used to transport items to a customer's vehicle and the specialized delivery carts can be conveniently placed in a cart drop-off area.

In accordance with the present invention there is provided a direct delivery shopping system that comprises an online order system which is accessible using a direct delivery shopping system website, order placement centers, delivery counters, customized sales receipts, specialized delivery containers and a direct delivery area.

The direct delivery shopping system's online ordering system has access to the direct delivery shopping system's inventory information and the available items in the distribution center. A customer can access the online order system through a computer interface such as the Internet. A customer profile can be used to shop and select specific sale items on the direct delivery shopping system's online order system. The items can be displayed with an item identification or coding system developed by a specific merchant using the direct delivery shopping system. After direct communication with the direct delivery shopping system's online order system, the customer finalizes the sale and receives a customized sales receipt for the purchase. The customer can also reserve a pick-up time on the same day orders are made.

The direct delivery shopping system features order placement centers which can be used to place orders. The order placement centers have access to the direct delivery shopping system's online order system and are located at a reasonable distance from the direct delivery area. The order placement centers can be in separate rooms that are sufficiently sized to receive customers. They also have a sufficient amount of computers to allow customers to place orders and are located in a retail establishment that has sufficient space to integrate the order placement centers. The order placement centers can be accessorized with catalogs that are easily accessible for item review and decision. The catalogs can have instructions for payment, payment methods, item description, sale prices, and other information to effectuate sale of items. The catalogs can be attached to tables in the order placement center. The catalogs are generally adapted for generating and receiving orders.

Delivery counters are walk up counters staffed with employees who take orders on computers. This is face-to-face ordering which helps customers who are not proficient with computers or who require immediate assistance with order placements. The delivery counters also facilitate easier interaction with employees and help to resolve issues with orders. The delivery counters can also be accessorized with catalogs that are easily accessible for item review and decision. Employees at the delivery counters can scan customized sales receipts to verify delivery orders and to further expedite delivery of items.

Each customer receives a customized sales receipt which can have specific details for item retrieval. The customized sales receipt can include relevant sales and item retrieval information including a customer code, a list of items purchased, order number, any special request (for example: a special request for shopping bags), date and time for pickup, method of payment, specified conveyor belt number for pickup and availability of items.

The direct delivery shopping system's employees monitor the direct delivery shopping system's website for newly placed orders. In preparation for delivery, the employees assemble and package the items in specialized delivery containers. Specialized delivery containers have at least one monitor zone which indicates the status of the containers, allows the identification of the customer order, client information, list of product codes and time of delivery. The specialized delivery containers are constructed of a sturdy material and have a configuration that is compatible with the direct delivery area's conveyor belts. The surfaces of the specialized delivery containers can be color coded in order to designate the day of the week (for example: Saturday can be blue). The containers are assembled and stored for customer pickup in the direct delivery area which restricts customer access beyond the outer perimeter.

The customer retrieves the purchased items by showing the customized sales receipt at a conveyor belt in the direct delivery area. The customer can show any similar proof of purchase or personal identifying information to employees. The customer retrieves the packages from any of the plurality of conveyor belts in the system. Dissatisfied customers can express their dissatisfaction with the orders or process at a delivery counter. The conveyor belts can be adapted to transport and deliver large items such as flat-screen television sets, lawn mowers and computers.

The direct delivery area can have a polygonal configuration and is constructed in a manner that does not allow customer access into the direct delivery area. The direct delivery shopping system can be customized for an average store that is approximately 170,000 square feet and typically devote as much as 40% of the space to grocery items. It is sufficiently sized in order to house a plurality of delivery counters, conveyor belts, employee passageways, wall storage, storage areas for packaged items and transport elevators in the outer perimeter. The areas inside the direct delivery area are so spaced and so connected in order to retain the polygonal nature of the direct delivery area. The outer perimeter of the delivery area can have a wall extending along the polygonal configuration. The wall can be made of a glass material. The customers can then walk the outside areas of the delivery area hub and retrieve items that have been ordered. Customers can also view items which can be displayed in the wall storage.

As an alternative embodiment, the invention as described in the preferred embodiment is integrated into an established grocery store, retail establishment or marketing system.

As an alternative embodiment, the building as described can have a parking area, basement, additional floors, and interior and exterior decorative elements that can be designated as unique to the shopping system. The basement can be used for storage, warehousing, bathrooms, truck deliveries or any other designated use. The first and second additional floors can be used for the standard operations of a retail establishment including housing for order retrieval stations, employee offices, large storage, cafeteria, employee lounge and bathrooms.

Additional advantages and features of the present invention will become more apparent when considered in light of the following specification and drawings.

### BRIEF DESCRIPTION OF THE SEVERAL VIEWS OF THE DRAWING

FIG. 1 is a top view of a floor plan according to a preferred embodiment of the direct delivery shopping system.

FIG. 2 shows a customer accessing the direct delivery shopping system's website using a personal computer.

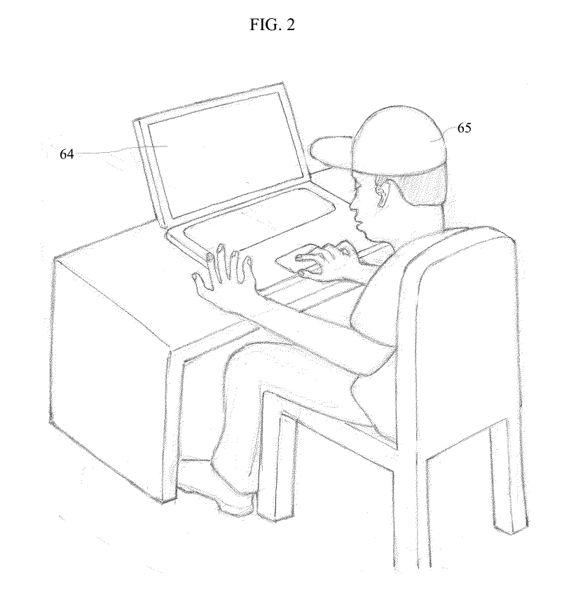

FIG. 3 is a perspective view of an order placement center.

FIG. 4 is a representation of one embodiment of a customized sales receipt.

FIG. 5 is a perspective view of a specialized delivery container with attached wheels.

FIG. 6 is a perspective of an employee transporting specialized delivery containers using large transport carts.

FIG. 7 is a perspective view of a plurality of delivery counters, conveyor belts and computers.

FIG. 8 is a perspective view of large items being delivered on a conveyor belt in the direct delivery area.

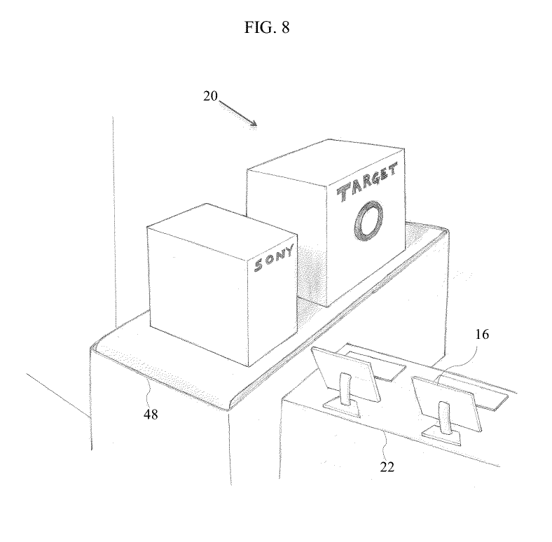

FIG. 9 is a top view of a floor plan of a basement that can be included in the direct delivery shopping system 10 showing a delivery ramp 94, delivery trucks 98, freight elevators 102, mid-sized bathrooms 103, employee elevators 106, transport elevators 108, large transport carts 114, shelving 116, large storage area 118, employee workbenches 122, employee lockers 112 and inventory terminals 124.

FIG. 10 is a top view of a floor plan of a first additional floor 126 that can be included in the direct delivery shopping system showing large bathrooms 104, freight elevators 102, employees 12 transporting specialized delivery containers 32 on large transport carts 114, transport elevators 108, employee elevators 106, dry goods storage areas 134 and large storage areas 118.

FIG. 11 is a top view of a floor plan of a second additional floor that can be included in the direct delivery shopping system showing an employee lounge 138, a small bathroom 142, additional large bathrooms 104, cafeterias 144, freight elevators 102, transport elevators 108, employee elevators 106, sitting areas 150 and order retrieval stations 146.

FIG. 12 is a perspective view of a store 30 with additional floors and decorative elements.

### DETAILED DESCRIPTION OF THE INVENTION

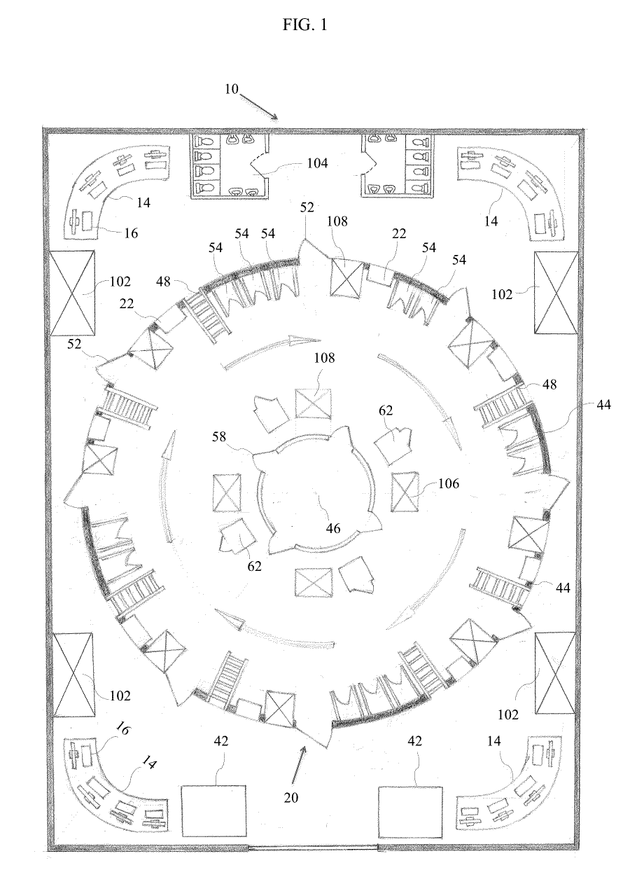

Referring now to the drawings, FIG. 1 shows the preferred embodiment of the direct delivery shopping system 10 generally indicated by the numeral 10.

FIG. 1 shows the direct delivery shopping system 10, which can require the use of computers 16 in order to shop and to complete the final sale of items. The direct delivery shopping system 10 can have a website with an online order system which can be accessed using a personal computer 64. A customer 65 can access a website created for use of the direct delivery shopping system 10 and to create a customer code 66. The customer code 66 can be re-used for subsequent purchases by the customer 65. The customer 65 can use the online order system to finalize a sale and to produce a customized sales receipt 24. The customer 65 can reserve a retrieval date 26 and retrieval time 28 for the orders.

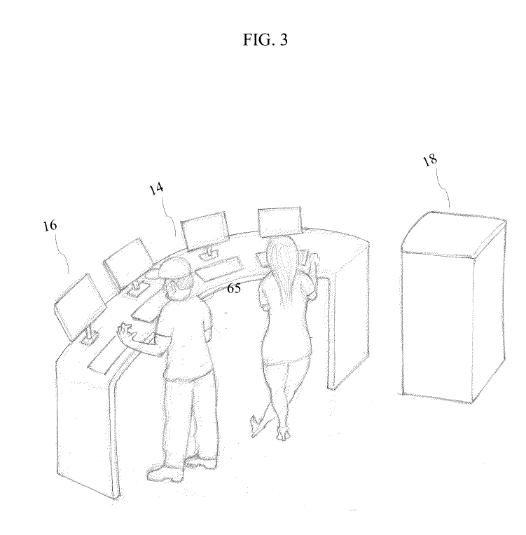

A customer can purchase items and shop at a plurality of order placement centers 14 as shown in FIG. 1 and FIG. 3. The order placement centers 14 can have a plurality of computers 16 and a drop-box 18 for receiving hand-written or write-in orders. The order placement centers 14 can be located in close proximity to the direct delivery area 20. The customer 65 can also purchase items using a cell phone, tablet or any medium with connection to the Internet. In addition, a customer 65 can use a catalog or any additional printed media that can be established in order to display and procure the final sale of items.

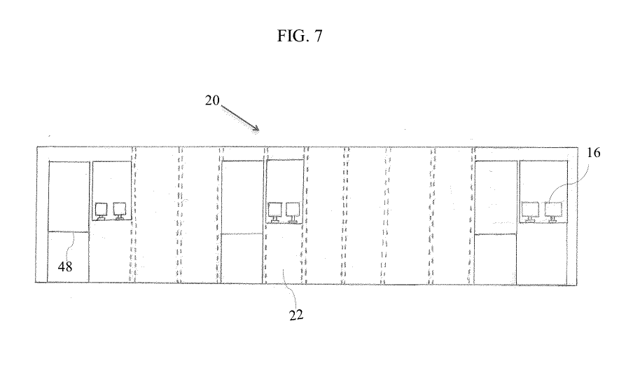

Orders can also be placed at a plurality of delivery counters 22. The delivery counters 22 are shown in FIG. 1 and FIG. 7. The delivery counters 22 have a plurality of computers 16 and can be staffed with an employee 12 to complete orders. The delivery counters 22 can be sufficiently sized in order to facilitate the transfer of small items to a customer 65.

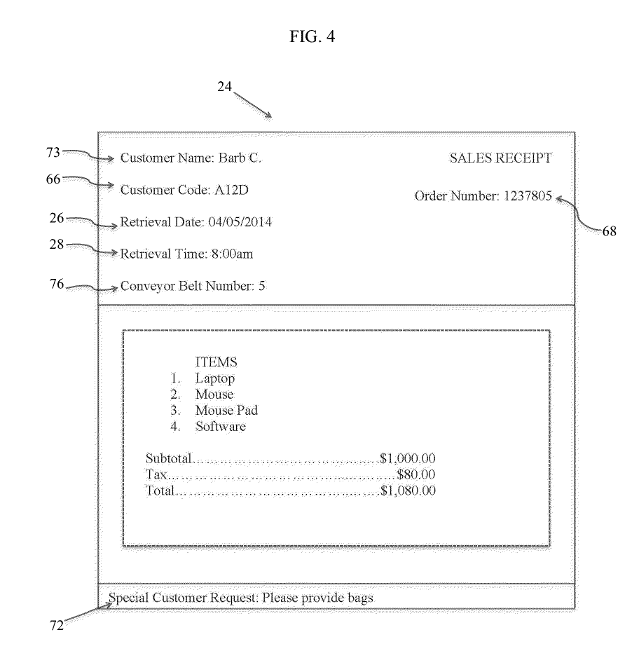

FIG. 4 is representative of a customized sales receipt 24 which can be used in the direct delivery shopping system 10. The customized sales receipt 24 can specify the retrieval date 26 and retrieval time 28 for an order. The customized sales receipt 24 can have an order number 68, special requests from a customer 72, customer name 73, customer code 66 and a conveyor belt number 76.

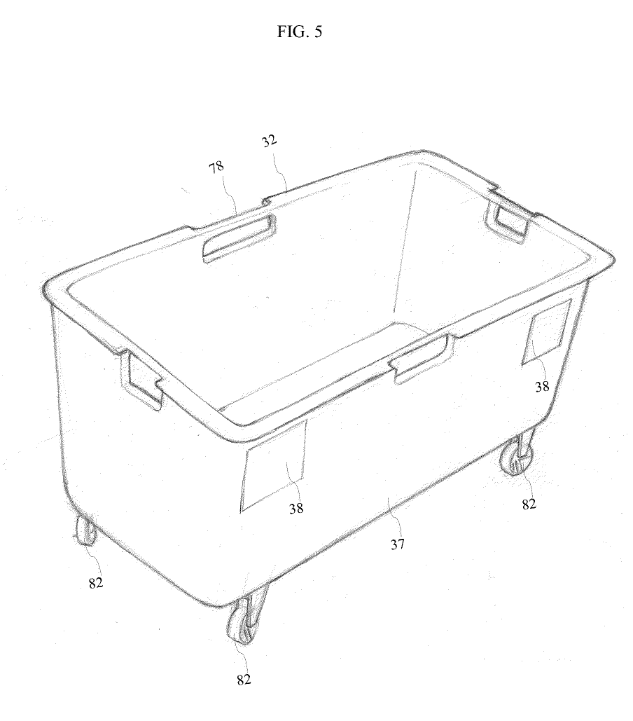

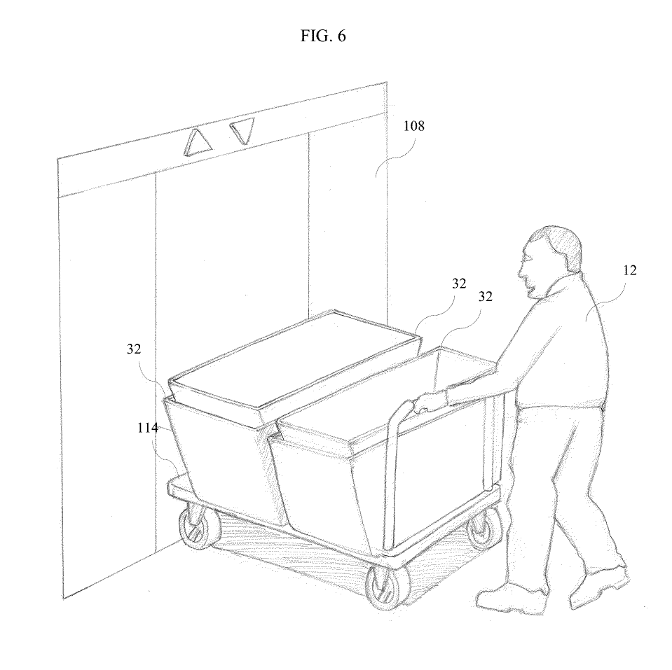

FIG. 5 and FIG. 6 show the specialized delivery containers 32 that can be used to transport and pack purchased items. The specialized delivery containers 32 have at least one monitor zone 38 on the exterior surface 37. The monitor zone 38 of the specialized delivery containers 32 can be labeled with a customer code 66, customer name 73, retrieval date 26 and retrieval time 28. The specialized delivery containers 32 can have a configuration that is compatible with the size of a conveyor belt 48. The specialized delivery containers 32 can also be made of a sturdy plastic material. The surface of the specialized delivery containers 32 can be color-coded in order to designate the day of the week. For example, blue containers can be used to deliver items on Tuesdays. A color-coded specialized delivery container 32 would be easy to restock and remove from the direct delivery area 20. After use, a specialized delivery container can be conveniently restocked at a cart drop-off area 42.

The specialized delivery containers 32 can also be manufactured in various sizes and can have handles 78 for quick and efficient transport to a customer's vehicle. The specialized delivery container 32 can also have wheels 82 that would facilitate the transport of bulky purchases or heavy items.

FIG. 1 shows the direct delivery area 20 which consists of an outer perimeter 44 and a central area 46. The outer perimeter 44 has a plurality of delivery counters 22, conveyor belts 48, employee passageways 52, wall storage 54, transport elevators 108 and employee elevators 106. The central area 46 has a centrally located cart storage area 58, a plurality of transport elevators 108, a plurality of employee elevators 106 and a plurality of small storage areas 62.

The delivery counters 22, conveyor belts 48, employee passageways 52, wall storage 54 and transport elevators 108 are located in the outer perimeter 44 of the direct delivery area 20 and are so spaced and so connected in order to give the outer perimeter 44 of the direct delivery area 20 a polygonal nature.

The direct delivery area 20 can be sufficiently sized in order to house a plurality of delivery counters 22, conveyor belts 48, employee passageways 52, cart storage areas 58, small storage areas 62, wall storage 54 and transport elevators 108. The outer perimeter 44 of the direct delivery area 20 can have a wall extending around the outer perimeter 44. The conveyor belts 48 can be labeled in sequential order in order to expedite the pick-up process.

The cart storage area 58 can be placed in the central area 46 of the direct delivery area 20. The cart storage area 58 can be used to store produce, dairy, frozen food and other sale items. The transport elevators 108, employee elevators 106 and small storage area 62 can be angularly displaced from the cart storage areas 58. This would provide a convenient workflow for an employee 12 as he or she exits elevators with carts and delivers orders to conveyor belts.

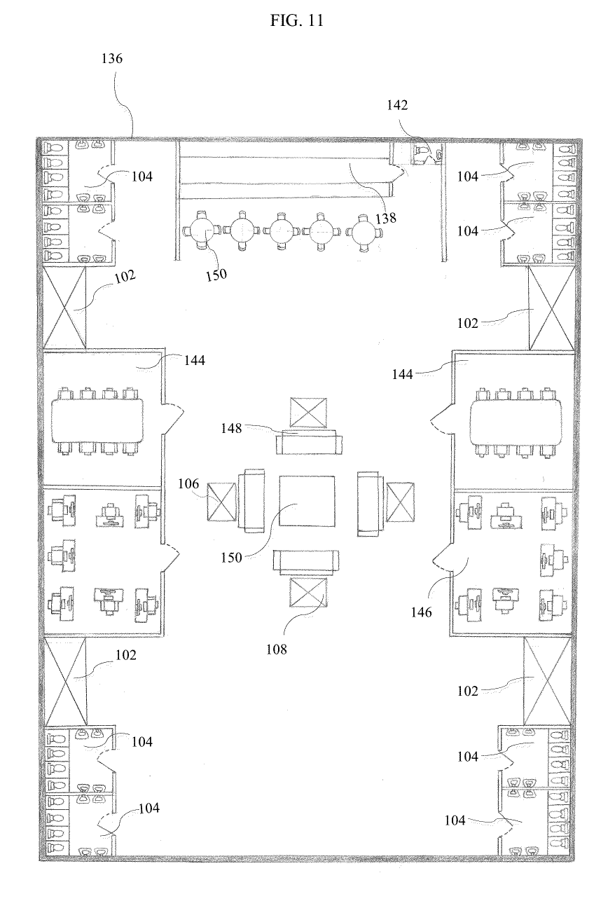

The direct delivery area 20 can be integrated into an established store 30 and can have a first additional floor 126 and a second additional floor 136. FIG. 11 is a perspective view of a store 30 which can integrate the direct delivery shopping system 10.

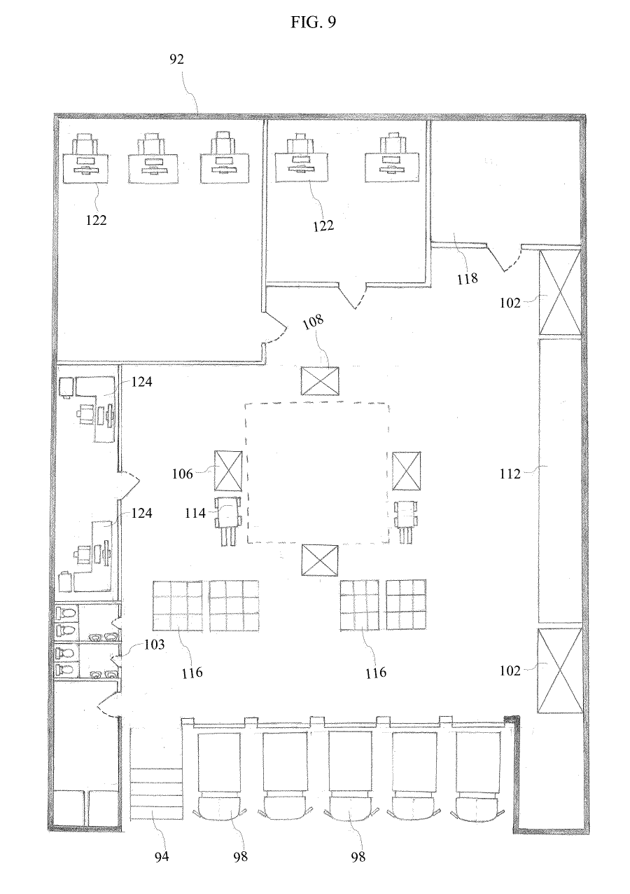

The direct delivery shopping system 10 of this invention can also have a basement 92. The basement 92 can be equipped with a delivery ramp 94. FIG. 9 shows the top view of a basement plan that can be included in the direct delivery shopping system 10. The basement 92 can be equipped with a delivery ramp 94, delivery trucks 98, freight elevators 102, mid-sized bathrooms 103, employee elevators 106, transport elevators 108, large transport carts 114, shelving 116, large storage area 118, employee workbenches 122, employee lockers 112 and inventory terminals 124.

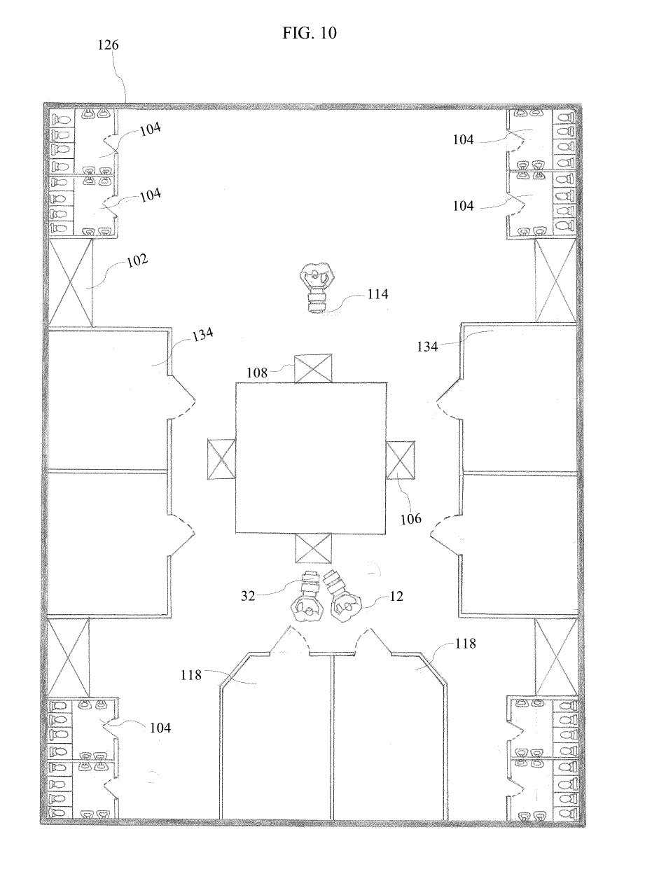

FIG. 10 shows a floor plan that can be representative of a first additional floor 126 that can be included in the direct delivery shopping system 10. The first additional floor 126 can have large bathrooms 104, freight elevators 102, employees 12 transporting specialized delivery containers 32 on large transport carts 114, transport elevators 108, employee elevators 106, dry goods storage areas 134 and large storage areas 118.

FIG. 11 shows a floor plan that can be representative of a second additional floor 136 that can be included in the direct delivery shopping system 10. The second additional floor 136 can have an employee lounge 138, a small bathroom 142, additional large bathrooms 104, cafeterias 144, freight elevators 102, transport elevators 108, employee elevators 106, sitting areas 150 and order retrieval stations 146.

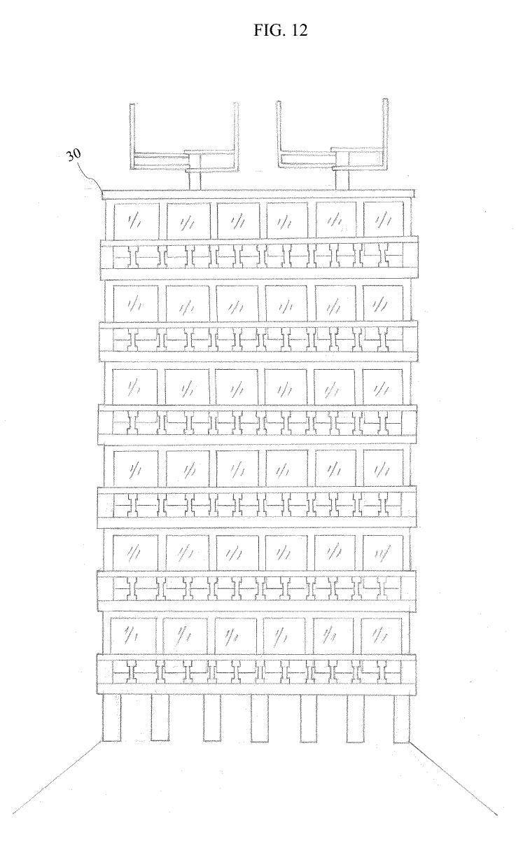

FIG. 12 is a perspective view of a store 30 that can be adapted to integrate the direct delivery shopping system 10.

What is claimed is:

1. A direct delivery shopping system comprising:
a. an online order system, wherein said online order system shows for-sale items on a website;
b. a plurality of order placement centers, said order placement centers having a plurality of computers and at least one drop-box for receiving an order;
c. a plurality of delivery counters, said delivery counters having a plurality of said computers and are staffed with at least one employee to complete said order;
d. a customized sales receipt wherein said customized sales receipt specifies the retrieval date and retrieval time that said order can be retrieved;
e. a plurality of specialized delivery containers, said specialized delivery containers having at least one monitor zone on the side surface;
f. a direct delivery area comprising an outer perimeter and a central area, said outer perimeter having a plurality of said delivery counters, conveyor belts, employee passageways, wall storage, and transport elevators, said central area having a cart storage area, a plurality of said transport elevators, a plurality of employee elevators and a plurality of small storage areas, said plurality of said delivery counters, said conveyor belts, said employee passageways, said wall storage and said transport elevators being in said outer perimeter and being so spaced and so connected in order to retain the polygonal nature of said outer perimeter of said direct delivery area.

2. The online order system of claim 1 wherein said online order system can be accessed using a personal computer.

3. The website in claim 1 wherein said customer can create a customer code to identify said customer.

4. The online order system in claim 1 wherein said online order system can be used to finalize a sale and produce said customized sales receipt.

5. The online order system in claim 1 wherein said customer can reserve said retrieval date and said retrieval time for said orders using said online order system.

6. The computer in claim 1 wherein said computer has access to said online order system.

7. The order placement centers in claim 1 wherein said delivery counters are located in close proximity to said direct delivery area.

8. The delivery counters of claim 1 wherein said delivery counters can be sufficiently sized in order to facilitate the transfer of large items.

9. The customized sales receipt of claim 1 wherein said customized sales receipt can have an order number, special requests from said customer, said customer code and a conveyor belt number.

10. The specialized delivery containers in claim 1 wherein said monitor zone of said specialized delivery containers can be labeled with said customer code, said retrieval date and said retrieval time.

11. The specialized delivery containers in claim 1 wherein said specialized delivery containers can have a configuration that is compatible with the size of said conveyor belts.

12. The specialized delivery containers in claim 1 wherein said specialized delivery containers can be made of a sturdy plastic material.

13. The specialized delivery containers in claim 1 wherein said surface of said specialized delivery containers can be color-coded in order to designate the day of the week.

14. The specialized delivery containers in claim 1 wherein said specialized delivery containers can be manufactured in various sizes.

15. The specialized delivery containers in claim 1 wherein said specialized delivery containers can have handles attached to said surface of said specialized delivery container.

16. The specialized delivery containers in claim 1 wherein said specialized delivery containers can have wheels attached to the bottom surface of said specialized delivery containers.

17. The plurality of conveyor belts in claim 1 wherein said plurality of conveyor belts can be labeled in sequential order

18. The direct delivery area of claim 1 wherein said direct delivery area is sufficiently sized in order to house a plurality of said delivery counters, said conveyor belts, said employee passageways, said cart storage areas, said small storage areas, said wall storage and said transport elevators.

19. The direct delivery area of claim 1 wherein said outer perimeter of said direct delivery area can have a wall extending along said outer perimeter.

20. The direct delivery area of claim 19 wherein said wall of said direct delivery area can be glass.

21. The cart storage area of claim 1 wherein said cart storage area can be placed in said central area of said direct delivery area.

22. The direct delivery area of claim 1 wherein said transport elevators, said employee elevators and said small storage areas can be angularly displaced from said cart storage areas.

23. The direct delivery area of claim 1 wherein said direct delivery area can be integrated into an existing store.

24. The direct delivery shopping system of claim 1 wherein said direct delivery shopping system can have a plurality of cart drop-off areas.

25. The direct delivery shopping system of claim 1 wherein said direct delivery shopping system can have a first additional floor and a second additional floor.

26. The direct delivery shopping system of claim 1 wherein said direct delivery shopping system can have a basement.

27. The direct delivery shopping system of claim 26 wherein said basement can be adapted to receive delivery of inventory.
